(19) United States
(12) Patent Application Publication
(10) Pub. No.: US 2025/0135469 A1
(43) Pub. Date: May 1, 2025

(54) A CENTRIFUGAL SEPARATOR HAVING A HERMETIC INLET AND OUTLET

(71) Applicant: ALFA LAVAL CORPORATE AB, LUND (SE)

(72) Inventor: Leonard BORGSTRÖM, TYRESÖ (SE)

(73) Assignee: ALFA LAVAL CORPORATE AB, LUND (SE)

(21) Appl. No.: 18/691,321

(22) PCT Filed: Sep. 8, 2022
(86) PCT No.: PCT/EP2022/074981

§ 371 Date: Mar. 12, 2024

(30) Foreign Application Priority Data
Sep. 23, 2021 (EP) 21198424.0

(51) Int. Cl. B04B 1/08; B04B 11/02; B04B 11/06

(52) U.S. Cl. CPC B04B 1/08; B04B 11/02; B04B 11/06

(57) ABSTRACT

A centrifugal separator for separating at least one liquid phase from a liquid feed mixture includes a centrifuge bowl arranged for rotation around an axis of rotation; a distributor dividing the centrifuge bowl interior into a central inlet chamber and an annular separation space; an inlet formed by a stationary inlet pipe and the central inlet chamber; a first liquid outlet for a separated liquid light phase arranged at the top of the centrifuge bowl at radius that is larger than the radius of the stationary inlet pipe; and a first stationary outlet pipe for receiving the separated liquid light phase from the first liquid outlet. The inlet is a hermetic inlet and the first stationary outlet pipe is hermetically sealed to the centrifuge bowl. The centrifugal separator includes a gap connecting the first liquid outlet or the first stationary outlet pipe to the inlet. The gap is not part of a mechanical seal and has an axial width that is more than 0.1 mm and is arranged for providing a leakage of separated liquid light phase from the first liquid outlet or the first stationary outlet pipe to the inlet during operation of the centrifugal separator.

### FIELD OF THE INVENTION

The present invention relates to the field of centrifugal separators, and more precisely to a centrifugal separator having a hermetic inlet and outlet.

### BACKGROUND OF THE INVENTION

Centrifugal separators are generally used for separation of liquids and/or for separation of solids from a liquid. During operation, liquid mixture to be separated is introduced into a rotating bowl and heavy particles or denser liquid, usually water, accumulates at the periphery of the rotating bowl whereas less dense liquid accumulates closer to the central axis of rotation. This allows for collection of the separated fractions, e.g. by means of different outlets arranged at the periphery and close to the rotational axis, respectively.

Generally, the outlets for the separated liquids may be formed in several different ways. A straightforward way of discharging a liquid phase is the use of so-called overflow or open outlets. However, in several applications, pressure is needed to discharge the separated liquids. This may be created by a stationary paring disc with specially designed channels.

The outlets may as an alternative be sealed. With a sealed design, the stationary inlet and outlet pipes are sealed in respect to the rotatable part of the separator by means of e.g. a mechanical seal or a liquid seal. The seal may be a hermetic seal, such as a mechanical hermetic seal, used when the material to be separated in the centrifugal separator must not be exposed to or come in contact with the atmosphere. Thus, a hermetic seal reduces the risk of any substance, such as oxygen, or particle in the atmosphere from contaminating the liquid feed or a separated phase. With a mechanical hermetic seal, there are no air-pockets during operation and control of the liquid interface position in the centrifuge bowl may be achieved by altering the backpressures/flow rate of the liquid phases.

An example of a separator with a mechanical seal is shown in U.S. Pat. No. 4,759,744, which shows a centrifugal separator having mechanical seals both at the inlets and the outlets.

However, introducing mechanical hermetic seals to separator may be complex, and there is thus a need in the art for a simple and robust hermetic design for a centrifugal separator.

### SUMMARY OF THE INVENTION

It is an object of the invention to at least partly overcome one or more limitations of the prior art. In particular, it is an object to provide a centrifugal separator having a hermetic inlet and a hermetically sealed outlet for the liquid light phase.

As a first aspect of the invention, there is provided a centrifugal separator for separating at least one liquid phase from a liquid feed mixture, comprising
a centrifuge bowl and arranged for rotation around an axis of rotation (X);
a distributor which divides the centrifuge bowl interior into a central inlet chamber and an annular separation space; wherein said separation space comprises a stack of separation discs arranged coaxially around the axis of rotation (X);
an inlet formed by a stationary inlet pipe and the central inlet chamber, wherein the stationary inlet pipe meets the centrifuge bowl axially from the top and is arranged for supplying the liquid feed mixture to the central inlet chamber;
a first liquid outlet for a separated liquid light phase arranged at the top of the centrifuge bowl at radius that is larger than the radius of the stationary inlet pipe,
a first stationary outlet pipe for receiving the separated liquid light phase from the first liquid outlet; wherein the inlet is a hermetic inlet and wherein the first stationary outlet pipe is hermetically sealed to the centrifuge bowl,
and wherein the centrifugal separator further comprises a gap which connects the first liquid outlet or the first stationary outlet pipe to the inlet, wherein said gap is not part of a mechanical seal and has an axial width that is more than 0.1 mm and is arranged for providing a leakage of separated liquid light phase from the first liquid outlet or the first stationary outlet pipe to the inlet during operation of the centrifugal separator.

As used herein, the term “axially” denotes a direction which is parallel to the rotational axis (X). Accordingly, relative terms such as “above”, “upper”, “top”, “below”, “lower”, and “bottom” refer to relative positions along the rotational axis (X). Correspondingly, the term “radially” denotes a direction extending radially from the rotational axis (X) and thus perpendicular to the rotational axis (X). A “radially inner position” thus refers to a position closer to the rotational axis (X) compared to “a radially outer position”. A “radial plane” is a plane extending in the radial direction and having a normal extending in the axial direction. In analogy, an “axial plane” is a plane extending in the axial direction and having a normal extending in the radial direction.

The first aspect of the invention is based on the insight that the centrifugal separator may be designed with a small gap between the outlet for the liquid light phase and the inlet. The liquid feed mixture of liquid phases and solids may have a higher density than the purified liquid light phase. When having high enough concentration of heavier components in the liquid feed mixture, then the pressure difference over the gap change sign and purified liquid light phase may flow from the first liquid outlet to the inlet. This prevents the purified liquid light from being contaminated by the liquid feed mixture.

Consequently, a separator according to the first aspect of the invention provides for a small leakage of the separated liquid light phase back to the feed mixture, but in turn provides for a simple mechanical seal to be used between the centrifuge bowl and the stationary outlet pipe for the liquid light phase.

With this design, no additional mechanical seal may be needed for sealing the stationary inlet pipe to the centrifuge bowl and for providing the hermetic properties to the inlet.

Thus, in embodiments, the centrifugal separator is free of any additional inlet seal for sealing the stationary inlet pipe to the centrifuge bowl. The present invention thus provides for a robust hermetic solution for a top-fed centrifugal separator, in which the inlet is a hermetic inlet and the outlet for the liquid light phase is hermetically and mechanically sealed.

Moreover, the hermetically sealed outlet for the liquid light phase makes it possible to control the radial position of the interface between separated phases within the bowl by adjusting the counter pressure at the liquid light phase outlet.

It is also well known that a hermetic inlet reduces inlet shear and thus gives largely improved separation.

Further, a traditional mechanical seal for the inlet may lead to an air lock in the inlet at start up. This may be prevented by the use of a nozzle allowing for leakage between the inlet to the outlet. Such a nozzle may therefore be avoided with the design of the present invention. Consequently, the present invention provides for a simple, robust design for hermetically sealing the inlet and the outlet for the liquid light phase.

The centrifugal separator is for separation of a liquid feed mixture. The liquid feed mixture may be an aqueous liquid or an oily liquid. As an example, the centrifugal separator may be for separating solids and potentially also another liquid, from the liquid feed mixture. The liquid mixture may for example be an oily mixture in which water and solids are separated from the oil.

The centrifugal separator usually comprises a frame, i.e. a non-rotating part and the centrifuge bowl may be supported by the frame by at least one bearing device. The centrifuge bowl is usually supported by a spindle, i.e. a rotating shaft, and may thus be mounted to rotate with the spindle. The axis of rotation (X) may extend vertically. Consequently, the centrifugal bowl may be arranged such that the centrifuge bowl is supported by the spindle at one of its ends, such at the top end of the spindle. The centrifugal separator may further comprise a drive member for rotating the spindle and the centrifuge bowl. The drive member may comprise an electrical motor or be provided beside the spindle and rotate the spindle and centrifuge bowl by a suitable transmission, such as a belt or a gear transmission.

The distributor divides the centrifuge bowl interior into a central inlet chamber and an annular separation space. The separation discs may be supported on the distributor and the distributor may be designed to accelerate and guide the liquid feed mixture from the central inlet chamber to the annular separation space.

The separation of the fluid mixture takes place in the annular separation space, which comprises a stack of separation discs. The separation discs may e.g. be of metal. Further, the separation discs may be frustoconical separation discs, i.e. having separation surfaces forming frustoconical portions of the separation discs. The separation discs are arranged coaxially around the axis of rotation (X) at a distance from each other such that to form passages between each two adjacent separation discs. The separation discs in the disc stack may be arranged such that the liquid mixture is introduced into the disc stack from a radially outer position. Separation then takes place in the passages between each two adjacent separation discs of the stack.

The centrifugal separator also comprises an inlet for liquid mixture to be separated (the liquid feed mixture). The inlet is formed by a stationary inlet pipe and the central inlet chamber. The stationary inlet meets the centrifuge bowl axially from the top and is arranged for supplying the liquid feed mixture to the central inlet chamber. The central inlet chamber may be arranged within the distributor and is arranged for receiving the liquid feed mixture. The stationary inlet pipe may extend into the centrifuge bowl, such as into the central inlet chamber. However, the stationary inlet may also meet the centrifuge bowl axially above the central inlet chamber. Thus, the centrifugal separator is a top-fed centrifugal separator.

There is a first liquid outlet for a separated liquid light phase arranged at the top of the centrifuge bowl at a larger radius than the stationary inlet pipe A “liquid light phase” refers to a separated liquid having a density that is lower than the density of a “liquid heavy phase”. Thus, the liquid feed mixture may be separated into at least a liquid light phase and a liquid heavy phase. However, the liquid feed mixture may be separated to a single liquid phase and e.g. a solids phase. In such case, there first liquid outlet is the only outlet for a separated liquid phase.

The first liquid outlet may be a “first liquid outlet zone”, which thus may be arranged downstream of the separation discs, i.e. the zone in the centrifuge bowl to which liquid light phase has been guided before being discharged to the first stationary outlet pipe.

The inlet is a hermetic inlet, i.e. a gas-tight inlet. However, the inlet is not sealed against the first liquid outlet for the separated liquid light phase.

The first liquid stationary outlet pipe is hermetically sealed to the centrifuge bowl. This may be performed by one mechanical seal arranged at the top of the centrifuge bowl. The mechanical seal may be a double mechanical seal, i.e. comprising a rotatable portion and a stationary portion forming the sealing interface therebetween.

The gap which connects the first liquid outlet or the first stationary outlet pipe to the inlet is a gap that provides a leakage of separated liquid light phase to the inlet, i.e. to the stationary inlet pipe or the central inlet chamber, during operation of the centrifugal separator. The gap is formed between rotating and non-rotating parts of the centrifugal separator. With such a design, no additional seal between the stationary inlet pipe and the centrifuge bowl may be needed.

The gap may be a circumferential gap. i.e. extending a full turn around the axis of rotation (X).

The gap may extend in the radial direction, to provide a radial flow from the first liquid outlet or the first stationary outlet pipe to the inlet during operation. However, the gap may also extend in any other suitable direction.

In embodiments of the first aspect, the gap is arranged axially between the top of the distributor and the stationary inlet pipe.

Hence, the stationary inlet pipe may extend almost all the way down to the distributor, and the gap may be formed between the end of the inlet pipe and the top of the distributor.

The gap formed has an axial width that is more than 0.1 mm. The width may thus be the distance between a stationary part and a rotatable part of the separator that forms the gap therebetween.

In embodiments of the first aspect, the gap has an axial width that is more than 0.3 mm, such as more than 0.5 mm, such as more than 1 mm.

The width of the gap is thus wider than the gap found in a traditional mechanical seal, i.e. wider than the gap found between stationary and rotatable portions of a mechanical double seal. Consequently, the gap is not part of a mechanical seal. Thus, the gap is a gap other than any gap formed between a rotatable surface and a stationary surface in a mechanical seal.

In embodiments of the first aspect, the gap has an axial width that is less than 10 mm, such as less than 5 mm.

As an example, the gap may have an axial width that is between 0.1-10 mm, such as between 0.3-8 mm, such as between 0.5-5 mm, such as between 1-5 mm.

As a further example, the gap may have an axial width that is between 0.3-2 mm, such as between 0.5-1 mm. As a further example, the gap may have an axial width that is between 1-8 mm, such as between 2-7 mm, such as between 3-6 mm.

In embodiments of the first aspect, the gap is coated with an erosion resistant material. The erosion resistant material may be an alloy.

In embodiments of the first aspect, the stationary inlet pipe is arranged radially inside the first stationary outlet pipe, and further wherein the first liquid stationary outlet pipe is hermetically sealed to the centrifuge bowl by means of a mechanical seal.

Such a mechanical seal may be a double seal, i.e. comprising a stationary portion having a first sealing surface and a rotatable portion having a second sealing surface, and the sealing interface may be formed between the first and second sealing surfaces. The sealing interface may extend in the radial plane. The stationary portion may be attached to the first stationary outlet pipe, whereas the rotatable portion may be attached to the centrifuge bowl.

The central inlet pipe may thus be arranged within at least a portion of the first stationary outlet pipe. Thus, the stationary inlet pipe may be arranged within the first stationary outlet pipe at the position where they meet the centrifugal bowl.

Thus, due to the arrangement of the separator of the first aspect, one mechanical seal may seal the first liquid outlet and at the same time provide the hermetic properties of the inlet.

As an example, the gap may be arranged axially below the sealing interface formed by said mechanical seal.

In embodiments of the first aspect, the central inlet chamber is arranged within the distributor. Further, the inner radius of the central inlet chamber may gradually increase from the upper portion to the lower portion of the distributor.

As seen in an axial plane, the central inlet chamber may have a frustoconical cross-section with the base axially at a lower portion of the distributor and the top at a higher portion. This may aid in converting the kinetic energy of the liquid mixture into liquid pressure.

In embodiments of the first aspect, the central inlet chamber comprises acceleration means for accelerating the liquid mixture to be separated. The acceleration means may be arranged for accelerating the liquid feed mixture to the rotating speed of the centrifugal bowl. The acceleration means may comprise wings, discs or the like, such as the acceleration means disclosed in WO2013/121009.

In embodiments of the first aspect, the centrifugal separator is further comprising a second liquid outlet for a separated liquid heavy phase. As an example, this second outlet may be an open outlet formed by an annular gravity disc.

The open outlet and the gravity disc forms the overflow outlet for the separated liquid heavy phase. The gravity disc may be an annular member that functions as a weir and determines the radial position of the overflow to the open outlet for the separated liquid heavy phase.

The second liquid outlet could also be a hermetic outlet, such as a hermetically sealed outlet sealed by a mechanical seal as discussed above. As an example, the second liquid outlet may be arranged at the bottom of the centrifuge bowl. Such a second outlet may be arranged close to the rotational axis. The centrifugal separator may be arranged for guiding separated liquid heavy phase from the annular separation space to the second liquid outlet. As an example, pipes extending into the annular separation space may be used.

However, as an alternative the second liquid outlet may be arranged at the top of the centrifuge bowl. Then, the centrifugal separator may be arranged for guiding separated liquid heavy phase from the annular separation space to the second liquid outlet over the stack of separation discs.

In embodiments of the first aspect, the centrifugal separator is further comprising at least one sludge outlet for a separated solids phase arranged at the periphery of the centrifuge bowl.

The centrifugal separator may thus be arranged to separate the liquid feed mixture into a liquid light phase, a liquid heavy phase and a solids phase, i.e. a sludge phase, and hence, the centrifugal separator may comprise a first liquid outlet for a heavy phase, a second liquid outlet for a light phase and sludge outlets for separated solids.

The at least one sludge outlet may be in the form of a set of open nozzles arranged for continuously discharging a separated sludge phase.

Such nozzles may be used when the sludge content of the liquid feed mixture is high.

As an alternative, the at least one sludge outlet is in the form of a set of intermittently openable outlets. Such outlets may thus be in the form of a plurality of peripheral ports that extend from the centrifuge bowl to a surrounding space outside the centrifuge bowl. The peripheral ports may be intermittently openable during a short time period, e.g. in the order of a fraction of a second, and permit total or partial discharge of sludge from the centrifuge bowl, using a conventional intermittent discharge system as known in the art.

The nozzles or the intermittently openable outlets may be equidistantly spaced around the axis of rotation (X).

As a second aspect of the invention, there is provided a method of separating at least one liquid phase from a liquid feed mixture, comprising the steps of
a) introducing the liquid feed mixture into a centrifugal separator according to the first aspect of the invention;
b) discharging at least one separated liquid phase from said centrifugal separator.

This aspect may generally present the same or corresponding advantages as the former aspect. Effects and features of this second aspect are largely analogous to those described above in connection with the first aspect. Embodiments mentioned in relation to the first aspect are largely compatible with the second aspect.

In embodiments of the second aspect, the at least one separated liquid phase is a liquid light phase and a liquid heavy phase.

In embodiments of the second aspect, the method further comprises a step c) of discharging a separated solids phase from said centrifugal separator.

The liquid feed mixture may have a density that is higher than the separated liquid light phase such that the flow in the gap of the separator is from the first liquid outlet or the first stationary outlet pipe to the inlet.

As an example, the liquid feed mixture may be an oil mixture comprising water and solids. Thus, water may be separated as the liquid heavy phase and oil may be separated as the liquid light phase.

Moreover, the water and solids may constitute at least 20 wt % of the liquid feed mixture.

In embodiments of the second aspect, the liquid feed mixture has a higher density than the separated liquid light phase.

In embodiments of the second aspect, the method is further comprising a step of adjusting the separation interface within the centrifuge bowl by adjusting the counter pressure on the liquid light phase outlet.

### BRIEF DESCRIPTION OF THE DRAWINGS

The above, as well as additional objects, features and advantages of the present inventive concept, will be better understood through the following illustrative and non-limiting detailed description, with reference to the appended drawings. In the drawings like reference numerals will be used for like elements unless stated otherwise.

FIG. 1 shows a schematic drawing of a centrifugal separator.

FIG. 2 shows a schematic drawing of an example of a centrifuge bowl which forms part of a centrifugal separator according to an embodiment of the present invention.

FIG. 3 shows a schematic drawing of how the inlet pipe meets the centrifuge bowl according to an embodiment of the present invention.

FIG. 4 shows a schematic drawing of an example of centrifuge bowl which forms part of a centrifugal separator according to an embodiment of the present invention.

FIG. 5 shows a flow chart of a method of separating a solids phase and at least one liquid phase from a liquid feed mixture.

### DETAILED DESCRIPTION

The centrifugal separator and the method according to the present disclosure will be further illustrated by the following description with reference to the accompanying drawings.

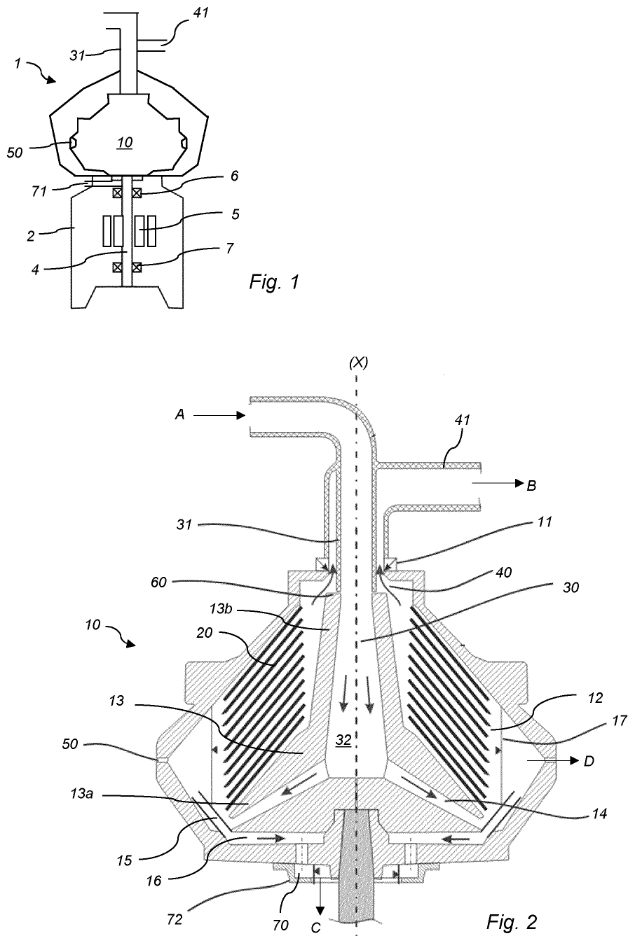

FIG. 1 show a cross-section of an embodiment of a centrifugal separator 1 configured to separate a sludge phase, a liquid light phase and a liquid heavy phase from a liquid feed mixture. The centrifugal separator 1 has a rotatable part comprising the centrifuge bowl 10 and drive spindle 4.

The centrifugal separator 1 is further provided with a drive motor 5. This motor 5 may for example comprise a stationary element and a rotatable element, which rotatable element surrounds and is connected to the spindle 4 such that it transmits driving torque to the spindle 4 and hence to the centrifuge bowl 10 during operation. The drive motor 5 may be an electric motor. Alternatively, the drive motor 5 may be connected to the spindle 4 by transmission means. The transmission means may be in the form of a worm gear having an element connected to the spindle 4 in order to receive driving torque. The transmission means may alternatively take the form of drive belts or the like, and the drive motor may alternatively be connected directly to the spindle 4.

The centrifuge bowl 10, shown in more detail in FIG. 2, is supported by the spindle 4, which is rotatably arranged in a stationary frame 2 around a vertical axis of rotation (X) in a bottom bearing 7 and a top bearing 6. The stationary frame 2 surrounds centrifuge bowl 10.

In the centrifugal separator 1 as shown in FIG. 1, liquid feed to be separated is fed from the top to the centrifuge bowl 10 via a stationary inlet pipe 31 extending into the centrifuge bowl 10.

After separation has taken place within the centrifuge bowl 10, separated liquid heavy phase is discharged from the bottom of the centrifuge bowl 10 through outlet 70, whereas separated liquid light phase is discharged through the first liquid outlet 40 to stationary outlet pipe 41 at the top. Separated sludge are continuously discharged via sludge outlets 50 in the form of open nozzles at the periphery of the centrifuge bowl 10.

The centrifugal separator 1 as described in relation to FIGS. 1 and 2 may be used in the oil and gas industry, e.g. for oil recovery from oil-sand, or in other applications where there are high demands on liquid-liquid-solids separation combined with large solids handling capacity.

FIG. 2. shows a more detailed view of the centrifuge bowl 10 of the centrifugal separator 1.

The inlet 30 to the centrifuge bowl is formed by the stationary inlet pipe 31, which meets the centrifuge bowl axially from the top, and the central inlet chamber 32 within the bowl. In this example, the inlet pipe 31 is extending into the bowl 10, The stationary inlet pipe is thus arranged for supplying the liquid feed mixture to the central inlet chamber 32, which is arranged within the distributor 13. This distributor delimits the central inlet chamber 32 from the annular separation space 12 in which the stack of separation discs is arranged.

The distributor 13 comprises a conical base portion 13a arranged to conduct liquid mixture from the central inlet chamber 13 to the annular separation space 12, and a central neck portion 13b extending upwards from the base portion 13a. The central inlet chamber 32 thus communicates with the separation space 12 via channels 14 situated in the conical base portion 13a. Further, the inner radius of the central inlet chamber 32 gradually increases from the upper portion to the lower portion of the distributor 13.

The annular separation space 12 comprises a stack 20 of separation discs that is arranged coaxially around the axis of rotation (X) and thus arranged to rotate together with the centrifuge bowl 10. The stack 20 is supported at its axially lowermost portion by the distributor 13. The separation discs of the disc stack 20 are frustoconical and extend outwardly and downwardly from the distributor 13. It should be noted that the separation discs also could extend outwardly and upwardly, or be formed as axial sheets, such as axial sheets having a curved cross-section in a radial plane.

The separation discs of the stack 20 are provided at a distance from each other by means of distance members (not disclosed) in order to form interspaces between adjacent separation discs, i.e. an interspace between each pair of adjacent separation discs. The stack 20 of separation discs therefore provide for an efficient separation of the liquid mixture into at least a liquid light phase and a solids phase. Depending on the feed mixture, also a liquid heavy phase may be separated between the separation discs in the disc stack 20. Thus, in the separation space 12, centrifugal separation of e.g. a liquid feed mixture to takes place during operation.

A first liquid outlet 40 for a separated liquid light phase is arranged at the top of the centrifuge bowl 10 at radius that is larger than the radius of the stationary inlet pipe 31. The first liquid outlet 40 thus forms an outlet zone to which separated liquid light phase is guided after having passed the stack 20 of separation discs.

The first liquid outlet 40 of the centrifuge bowl 10 is in fluid communication with a first stationary outlet pipe 41, which is thus arranged for receiving the separated liquid light phase from the first liquid outlet 40.

The centrifugal separator 1 further comprises a gap 60 which connects the inlet 30 and the first liquid outlet 40. This small gap 60 has an axial width that is more than 0.1 mm and is arranged for providing a leakage of separated liquid light phase from the first liquid outlet 40 to the inlet 30 during operation of the centrifugal separator. The gap 60 is in this example arranged axially between the top of the distributor 13 and the stationary inlet pipe 31 and has a width in the axial direction that is less than 5 mm, i.e. the gap has an axial width that is between 0.1 mm and 5 mm. The gap may extend in the radial direction a distance that is more than 1% of the diameter of the centrifuge bowl 10.

Moreover, the first stationary outlet pipe 41 is hermetically sealed to the centrifuge bowl 10 by means of a mechanical seal 11 between the centrifuge bowl 10 and the first stationary outlet pipe 41.

The mechanical seal 11 may be a double seal, such as comprising a rotatable sealing ring fitted to the centrifuge bowl 10 and a stationary sealing ring axially aligned with the first sealing ring around the axis of rotation (X) and fitted to the stationary outlet pipe 41. The rotatable sealing ring may be of a material that is harder than the stationary sealing ring. The mechanical seal may also comprise a resilient member, such as a spring, for bringing the rotatable and stationary sealing rings together, thereby forming a sealing interface between the two rings. However, this still means that a liquid seal film may be formed at the sealing interface during rotation of the rotatable sealing ring. The formed sealing interface may thus extend substantially in parallel with a radial plane with respect to the axis of rotation (X). The mechanical seal 11 is thus a mechanical seal that forms a hermetic seal between a stationary part and a rotatable part of the centrifugal separator 1.

The mechanical seal 11 also provides the hermetic properties to the inlet 30, although the inlet pipe itself 31 is not in direct contact with the portions of the mechanical seal 11

The hermetically sealed first liquid outlet and inlet reduces the risk of any substance, such as oxygen, or particle in the atmosphere from contaminating the liquid feed or the separated liquid light phase.

In the centrifugal bowl 10 of FIG. 1, the gap 60 is arranged axially below the sealing interface formed by the mechanical seal 11.

The centrifugal separator 1 further comprises a sludge outlet 50 for separated solids. This sludge outlet 50 is in the form of permanently open nozzles arranged at the periphery of the centrifuge bowl 10. The nozzles are distributed around the rotational axis (X) and each nozzle has a through channel via which liquid and finely divided solids can be ejected from the separating space 12. As an alternative to the nozzles, the centrifuge bowl 10 may be provided with outlets arranged for intermittent discharge of a sludge component of the liquid feed mixture. The opening of such outlets may be controlled by means of an operating slide (not shown) actuated by operating water, as known in the art. However, it is also to be understood that the centrifugal separator may be free of any outlets from separated sludge.

Moreover, the centrifugal separator 1 comprises a second liquid outlet 70 for a separated liquid heavy phase. This outlet is arranged at the bottom of the centrifuge bowl 10 and is an open overflow outlet formed by the annular gravity disc 72.

The second liquid outlet 70 communicates with a radially outer zone of the separating space 12 via channels 16 and a plurality of pipes 15 distributed around the rotational axis (X). As an alternative to the pipes 15, the centrifuge bowl 10 may be provided with channels integrated in the lower part of the centrifuge bowl 10, in which case the channels will constitute extensions of the channels 16 for creating the connection between the separation space 12 and the second liquid outlet 70. Further, the second liquid outlet 70 is in fluid connection with a second stationary outlet pipe 71, which is thus arranged for receiving the separated liquid light phase from the first liquid outlet 40.

During operation of the separator as shown in FIGS. 1 and 2, the centrifuge bowl 10 is brought into rotation by the drive motor 5. Via the stationary inlet pipe 31, liquid feed mixture to be separated is brought into the central inlet chamber 32, as shown with arrows “A” in FIG. 2. Due to the conical cross-section of the central inlet chamber 32, i.e. with its inner radius expanding through the distributor, kinetic energy of the liquid feed mixture may be transformed into pressure.

The liquid mixture is further guided through channels 14 to the annular separation space 12. Depending on the density, different phases in the liquid feed mixture is separated between the separation discs of the stack 20. Heavier component, such as a liquid heavy phase and a sludge phase, move radially outwards between the separation discs to the radially outer portion of the separation space 12. The liquid phase of lowest density, such as a liquid light phase, moves radially inwards between the separation discs and is forced through the liquid light phase outlet 40 to the first stationary outlet pipe 41, as shown with arrow “B” in FIG. 2. The liquid of higher density is instead forced out through the pipes 15 and passages 16 to the overflow outlet 70 for the liquid heavy phase, as indicated by arrows “C”. Thus, during separation, an interphase 17 between the liquid of lower density and the liquid of higher density is formed in the centrifuge bowl 10, such as radially outside the stack of separation discs 20 or within the disc stack 20. Solids, or sludge, accumulate at the periphery of the separation space 12 and is continuously ejected from the nozzles of the sludge outlet 50 by means of centrifugal force, as indicated by arrows “D”.

Due to the setup of the hermetically sealed first liquid outlet 40 and hermetic inlet 30, the position of the interface 17 may be regulated by adjusting a counter pressure of the first liquid outlet 40, e.g. by means of a valve (not shown) arranged downstream on the first stationary outlet pipe 41.

The process parameters of the centrifugal separator is further set so that the leakage through the gap 60 is in the direction from the first liquid outlet 40, or the first stationary outlet pipe 41, back to the inlet 30. Any negative effect from such a small internal recirculation is expected to be small compared to the gain. This is due to less inlet shear as compared to separators having an open inlet and/or an open outlet for the liquid light phase.

As a numerical example, a liquid feed mixture of an oily sand may comprise approximately 70% oil, 23% water and 7% solids. Since the water and solids content of such liquid feed mixture is denser than the clean oil, the liquid feed mixture in the channels 14 are much heavier than the oil within the stack 20. An estimated density difference of about 70 kg/m³ at diameters 100 mm and 600 mm at speed 3400 rpm would correspond to about 4 bars pressure difference over the gap 60, not taking any pressure drop in channels 14 and in the disc stack 20 into account. Such a pressure difference would be enough to create a backflow of clean oil from the first liquid outlet to the inlet 30. Thus, during more or less normal process parameters, the leakage in gap 60 would be from the first liquid outlet 40 to the inlet 30, and not the other way around.

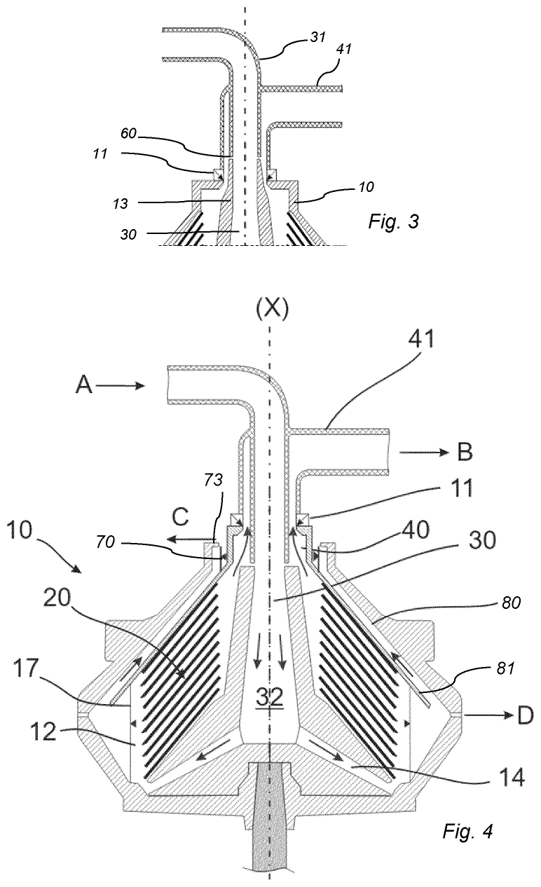

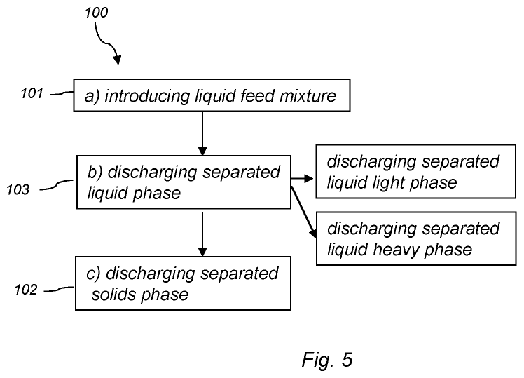

As discussed above, the stationary inlet pipe 31 does not have to extend into the centrifuge bowl 10. FIG. 3 illustrates a modification to the centrifuge bowl 10 discussed in relation to FIG. 2, in which the distributor 13 extends axially above the outer wall of the centrifuge bowl so that the stationary inlet pipe 31 meets the centrifuge bowl 10 at an axial position that is above the side walls bowl 10. Thus, in this example, the gap 60 is in a position that is axially above the mechanical seal 11 and therefore also above the sealing interface of the mechanical seal 60. In this example, the gap 60 is arranged for providing a leakage of separated liquid light phase from the first the first stationary outlet pipe 41 to the inlet 30 during operation of the centrifugal separator.

FIG. 4 shows an embodiment of a centrifuge bowl 10 in which both the first liquid outlet 40 and the second liquid outlet 70 are arranged on the top of the bowl 10. The centrifuge bowl functions as described in relation to the bowl 10 of FIG. 2, with the exception that the separated liquid heavy phase is guided above the top disc 81, which is arranged above the stack 20 of separation discs, in channels 80 to the second liquid outlet 70. The channels 80 are arranged between the top disc 81 and the inner surface of the centrifuge bowl 10. The second liquid outlet 70 is in the form of an overflow outlet that is arranged at radial position that is larger than the radial position of the first liquid outlet 40. Thus, the second liquid outlet 70 forms in this case an open overflow outlet, with a radial position determined by the size of the annular gravity disc 73. Liquid heavy phase exiting the second liquid outlet 70, as indicated by arrow “c” is collected in a stationary outlet pipe (not shown).

FIG. 4 illustrates a method 100 of separating at least one liquid phase from a liquid feed mixture. The method 100 comprises a step a) of introducing 101 the liquid feed mixture into a centrifugal separator 1. This centrifugal separator may thus be a centrifugal separator as disclosed herein above, such as the centrifugal separator discussed in relation to FIGS. 1-4.

The method 100 further comprises a step b) of discharging 103 at least one separated liquid phase from said centrifugal separator 1. Further, the at least one separated liquid phase may be a liquid light phase and a liquid heavy phase. Thus, the method 100 may comprise the steps of discharging 103 a liquid heavy phase and discharging a liquid light phase.

The method may further comprise a step c) of discharging 102 a separated solids phase from said centrifugal separator. Step c) may comprise ejecting the separated solids phase through a set of continuously open nozzles arranged at the periphery of the centrifuge bowl.

The liquid feed mixture may for example be an oil mixture comprising water and solids. The oil may thus be discharged as a separated liquid light phase, the water may be discharged as a separated liquid heavy phase. The water and solids may constitute at least 20 wt % of the liquid feed mixture.

The invention is not limited to the embodiment disclosed but may be varied and modified within the scope of the claims set out below. The invention is not limited to the orientation of the axis of rotation (X) disclosed in the figures. The term “centrifugal separator” also comprises centrifugal separators with a substantially horizontally oriented axis of rotation. In the above the inventive concept has mainly been described with reference to a limited number of examples. However, as is readily appreciated by a person skilled in the art, other examples than the ones disclosed above are equally possible within the scope of the inventive concept, as defined by the appended claims.

1. A centrifugal separator for separating at least one liquid phase from a liquid feed mixture, comprising:
a centrifuge bowl arranged for rotation around an axis of rotation;
a distributor dividing the centrifuge bowl interior into a central inlet chamber and an annular separation space, wherein said separation space comprises a stack of separation discs arranged coaxially around the axis of rotation;
an inlet formed by a stationary inlet pipe and the central inlet chamber, wherein the stationary inlet pipe meets the centrifuge bowl axially from a top thereof and is arranged for supplying the liquid feed mixture to the central inlet chamber;
a first liquid outlet for a separated liquid light phase arranged at the top of the centrifuge bowl at radius that is larger than a radius of the stationary inlet pipe;
a first stationary outlet pipe for receiving the separated liquid light phase from the first liquid outlet, wherein the inlet is a hermetic inlet and wherein the first stationary outlet pipe is hermetically sealed to the centrifuge bowl; and
a gap connecting the first liquid outlet or the first stationary outlet pipe to the inlet,
wherein said gap is not part of a mechanical seal and has an axial width that is more than 0.1 mm and is arranged for providing a leakage of separated liquid light phase from the first liquid outlet or the first stationary outlet pipe to the inlet during operation of the centrifugal separator.

2. The centrifugal separator according to claim 1, wherein the gap is arranged axially between a top of the distributor and the stationary inlet pipe.

3. The centrifugal separator according to claim 1, wherein the gap has an axial width that is less than 10 mm.

4. The centrifugal separator according to claim 1, wherein the gap has an axial width that is more than 0.3 mm.

5. The centrifugal separator according to claim 1, wherein the gap is coated with an erosion resistant material.

6. The centrifugal separator according to claim 1, wherein the stationary inlet pipe is arranged radially inside said first stationary outlet pipe, and
wherein said first stationary outlet pipe is hermetically sealed to the centrifuge bowl by a mechanical seal.

7. The centrifugal separator according to claim 6, wherein the gap is arranged axially below the sealing interface formed by said mechanical seal.

8. The centrifugal separator according to claim 1, wherein the central inlet chamber is arranged within the distributor, and
wherein the inner radius of the central inlet chamber gradually increases from an upper portion to a lower portion of the distributor.

9. The centrifugal separator according to claim 1, wherein the central inlet chamber comprises acceleration means for accelerating the liquid mixture to be separated.

10. The centrifugal separator according to claim 1, further comprising a second liquid outlet for a separated liquid heavy phase, wherein said second outlet is an open outlet formed by an annular gravity disc.

11. The centrifugal separator according to claim 10, wherein the second liquid outlet is arranged at a bottom of the centrifuge bowl.

12. The centrifugal separator according to claim 11, wherein the second liquid outlet is arranged at the top of the centrifuge bowl.

13. The centrifugal separator according to claim 1, further comprising at least one sludge outlet for a separated solids phase arranged at a periphery of the centrifuge bowl.

14. A method of separating at least one liquid phase from a liquid feed mixture, comprising the steps of:
introducing the liquid feed mixture into the centrifugal separator according to claim 1; and
discharging at least one separated liquid phase from said centrifugal separator.

15. The method according claim 14, wherein the at least one separated liquid phase is a liquid light phase and a liquid heavy phase.

16. The method according to claim 15, wherein the liquid feed mixture is an oil mixture comprising water and solids.

17. The method according to claim 16, wherein the water and solids constitute at least 20 wt % of the liquid feed mixture.

18. The centrifugal separator according to claim 1, wherein the gap has an axial width that is less than 5 mm.

19. The centrifugal separator according to claim 1, wherein the gap has an axial width that is more than 0.5 mm.

20. The centrifugal separator according to claim 1, wherein the gap has an axial width that is more than 1 mm.
